(19) United States
(12) Patent Application Publication
(10) Pub. No.: US 2026/0158692 A1
(43) Pub. Date: Jun. 11, 2026

(54) TOMATO SCORING DEVICE

(71) Applicant: Nancy Christopherson, Lakeville, MN (US)

(72) Inventor: Nancy Christopherson, Lakeville, MN (US)

(21) Appl. No.: 18/977,471

(22) Filed: Dec. 11, 2024

(51) Int. Cl. B26D 3/08; B26D 1/00

(52) U.S. Cl. CPC B26D 3/08; B26D 1/0006; B26D 2001/004; B26D 2001/006; B26D 2210/02

(57) ABSTRACT

A tomato scoring device includes a base, a support projection, and four blades. The base has a top surface, a bottom surface, and a perimeter surface connecting the top surface and the bottom surface. The support projection is positioned on the top surface of the base. Four blades are mounted in the support projection. The blades are positioned in a cross shape such that the blades are arranged in two aligned intersecting pairs perpendicular to one another. Each of the blades includes an exposed portion projecting out of the support projection a distance sufficient only to pierce a skin of a tomato when the tomato is pressed into the blades to create a cross-shaped cut.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fruit and vegetable cutting tools and more particularly pertains to a new tomato scoring device for making a cross-cut or scoring mark in a skin of a tomato. When preparing tomato-based foods, such as salsa, the first step is to score the skin on the bottom of the tomatoes using a paring knife to score an X-shaped cut or mark on the bottom. The scoring allows the skin to peel off easily during the blanching step. However, repeated cutting with a paring knife, especially when cutting dozens of tomatoes, can cause repetitive motion pain in the wrists and hands. In addition, some of the cuts may be inaccurate, such as not through the skin or too deep into the skin. The tomato scoring device makes it easy to quickly form the X-shaped cut in the tomato of a consistent shape and depth without strain on the hands or wrists.

### (2) Description of Related Art including information disclosed under 37 CFR 1.97 and 1.98

The prior art relates to fruit and vegetable cutting tools that are used to cut into slices or sections. The prior art, as best understood, does not disclose a tomato scoring device that includes a base, a support projection, and four blades, wherein the blades are positioned in a cross shape and include an exposed portion projecting out of the support projection a distance sufficient only to pierce a skin of a tomato when the tomato is pressed into the blades to create a cross-shaped cut.

### BRIEF SUMMARY OF THE INVENTION

An embodiment of the disclosure meets the needs presented above in a tomato scoring device generally comprising a base, a support projection, and four blades. The base has a top surface, a bottom surface, and a perimeter surface connecting the top surface and the bottom surface. The support projection is positioned on the top surface of the base. Four blades are mounted in the support projection. The blades are positioned in a cross shape such that the blades are arranged in two aligned intersecting pairs perpendicular to one another. Each of the blades includes an exposed portion projecting out of the support projection a distance sufficient only to pierce a skin of a tomato when the tomato is pressed into the blades to create a cross-shaped cut.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tomato scoring device according to an embodiment of the disclosure.

FIG. 2 is a top view of an embodiment of the disclosure.

FIG. 3 is a side view of an embodiment of the disclosure.

FIG. 4 is a front view of an embodiment of the disclosure.

FIG. 5 is a cross-sectional view of an embodiment of the disclosure.

FIG. 6 is a perspective view of an embodiment of the disclosure.

FIG. 7 is a perspective view of a first alternative embodiment of the disclosure.

FIG. 8 is a side view of an embodiment of the disclosure in use.

FIG. 9 is a perspective view of a second alternative embodiment of the disclosure.

FIG. 10 is a perspective view of the second alternative embodiment of the disclosure.

FIG. 11 is a side view of a third alternative embodiment of the disclosure.

### DETAILED DESCRIPTION OF THE INVENTION

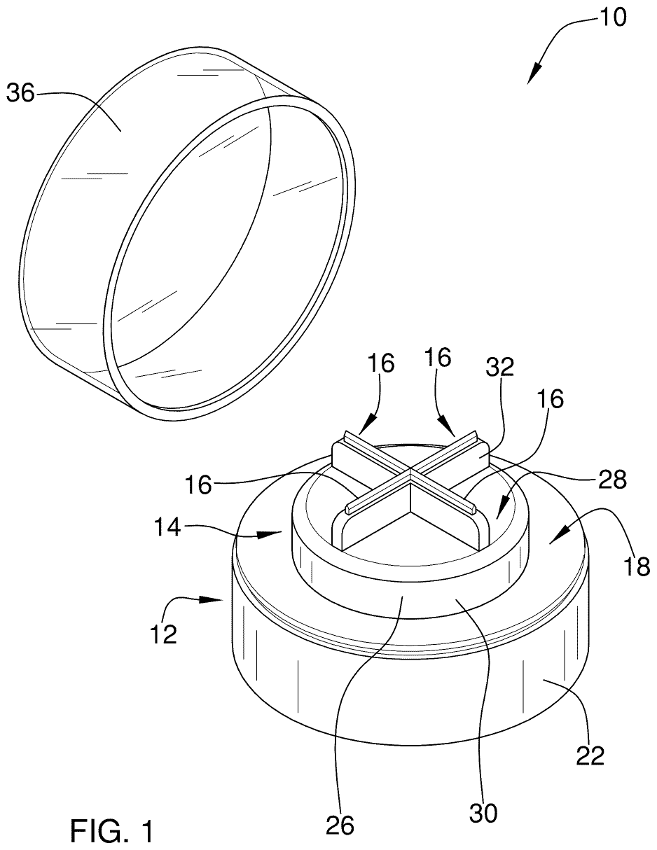

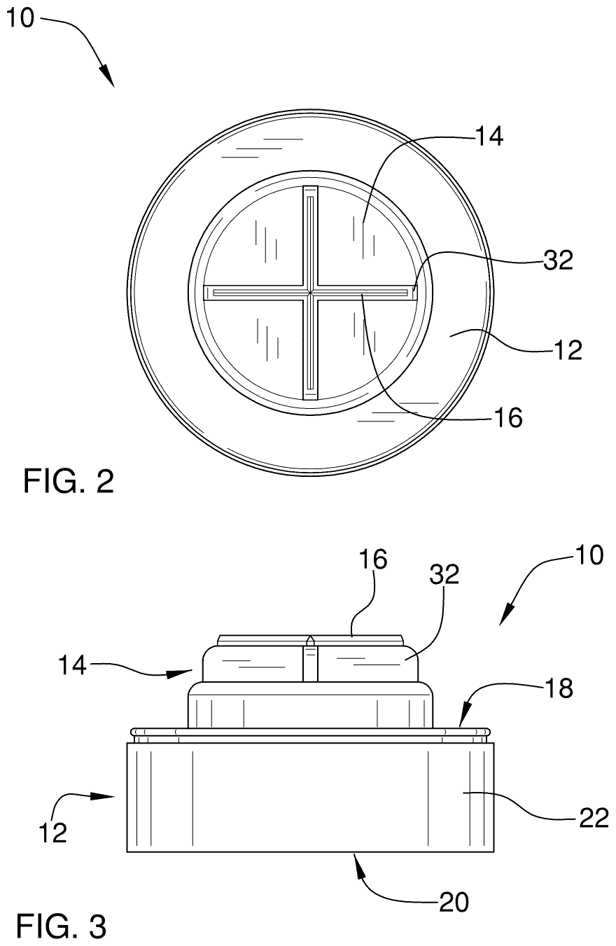

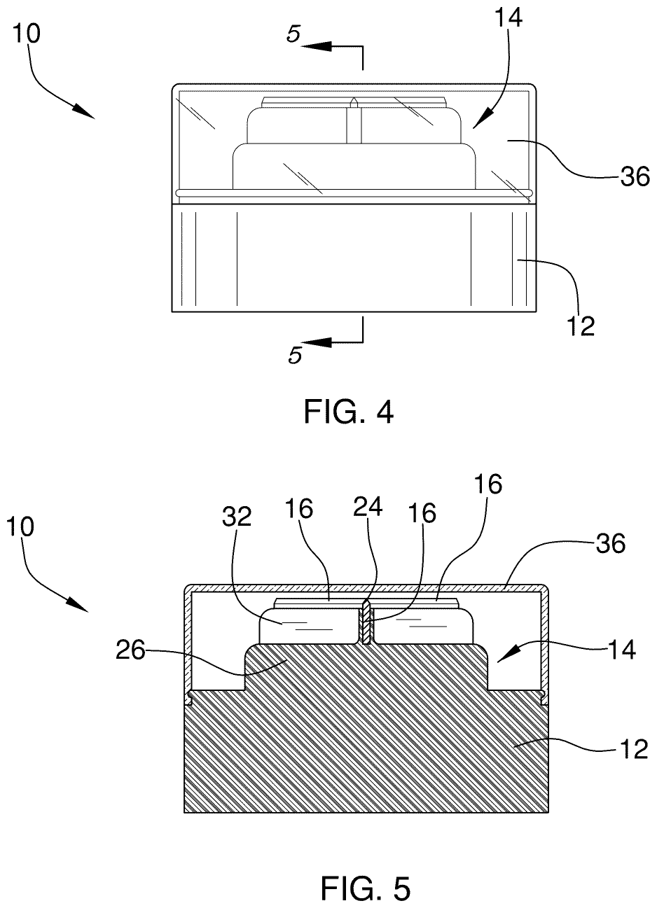

With reference now to the drawings, and in particular to FIGS. 1 through 11 thereof, a new tomato scoring device embodying the principles and concepts of an embodiment of the disclosure and generally designated by the reference numeral 10 will be described.

As best illustrated in FIGS. 1 through 11, the tomato scoring device 10 generally comprises a base 12, a support projection 14, and four blades 16. The base 12 has a top surface 18, a bottom surface 20, and a perimeter surface 22 connecting the top surface 18 and the bottom surface 20. The support projection 14 is positioned on the top surface 18 of the base 12. Four blades 16 are mounted in the support projection 14. The blades 16 are positioned in a cross shape such that the blades 16 are arranged in two aligned intersecting pairs perpendicular to one another. Each of the blades 16 includes an exposed portion 24 projecting out of the support projection 14 a distance sufficient only to pierce a skin of a tomato 70 when the tomato 70 is pressed into the blades 16 to create a cross-shaped cut.

The exposed portion 24 of the blades 16 can be best seen in FIG. 5, wherein most of the blade 16 shown is embedded in the support projection 14, while the exposed portion 24 projects out. In order to promote a cut of only the skin of the tomato 70, in the exemplary embodiment the exposed portion 24 of the blades 16 is in the range of 1.00 mm to 3.50 mm in height.

The blades 16 can be very thin, such as in the form of razor blades 16, though the blades 16 are shown in the drawings as being somewhat thicker for ease of view. The blades 16 are metal. However, in one possible embodiment, the blades 16 could be plastic that tapers to a very sharp edge. It should be noted that while four blades 16 are shown, it is possible for there to be only three blades 16, such as one longer blade and two shorter blades extending perpendicular to the longer blade. There could also be only two blades 16, wherein the blades 16 are formed to intersect, such as possibly via connecting notches.

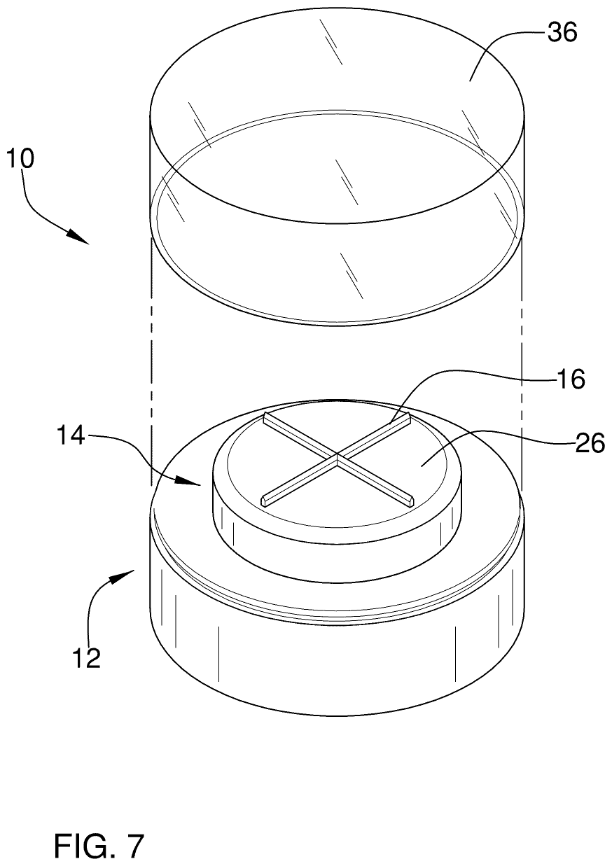

In the exemplary embodiment shown in FIG. 7, the support projection 14 is in the form of a platform 26 that includes an upper surface 28 and a side surface 30 extending to the top surface 18 of the base 12. The blades 16 are positioned to project out of the upper surface 28. In contrast, in the exemplary embodiment in FIGS. 1 through 6, the support projection 14 includes the platform 26 and a cross-shaped projection 32. The cross-shaped projection 32 is positioned to project out of the upper surface 28 of the platform 26. The blades 16 are mounted in the cross-shaped projection 32, as shown in FIG. 5. The platform 26, the base 12, and the cross-shaped projection 32 could be separate components coupled together, or they could be a one-piece structure, such as is shown in FIG. 5.

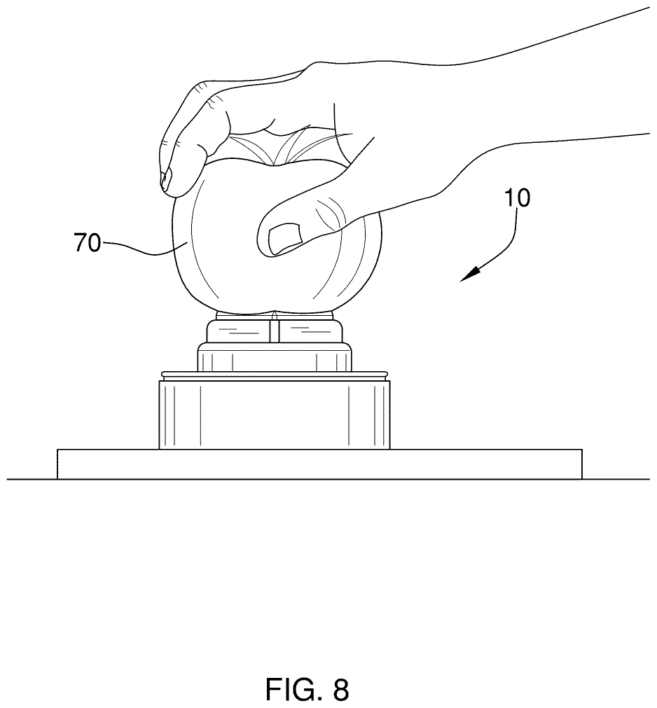

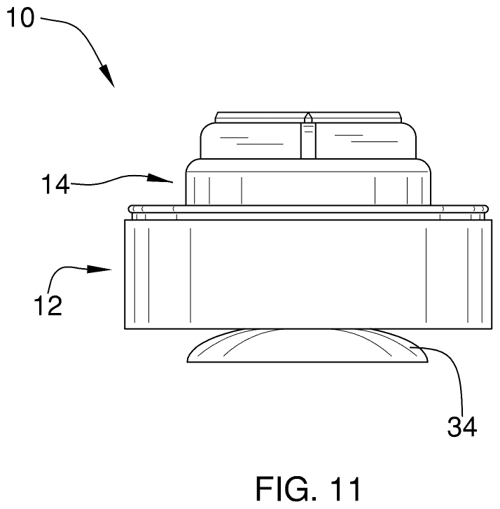

In the exemplary embodiment, the platform 26 is cylindrical and the base 12 is cylindrical. However, other shapes, such as squares, rectangles, and ovals, are within the scope of the disclosure. The tomato scoring device 10 is quite small. In the exemplary embodiment, the base 12 has a diameter in the range of 60 mm to 100 mm, and the platform 26 has a diameter smaller than the diameter of the base 12 in the range of 40 mm to 70 mm. For example, the base 12 might be 90 mm and the platform 26 might be 60 mm. Accordingly, the tomato scoring device 10 could be handheld when used, or it could be placed on a support surface, such as a table, countertop, or cutting board, such as is shown in FIG. 8. In the exemplary embodiment shown in FIG. 11, the tomato scoring device 10 could further include a suction cup 34 attached to the bottom surface 20 of the base 12. Alternatively, the base 12 could include a layer of gripping material, such as rubber or plastic, to help prevent sliding movement when in use.

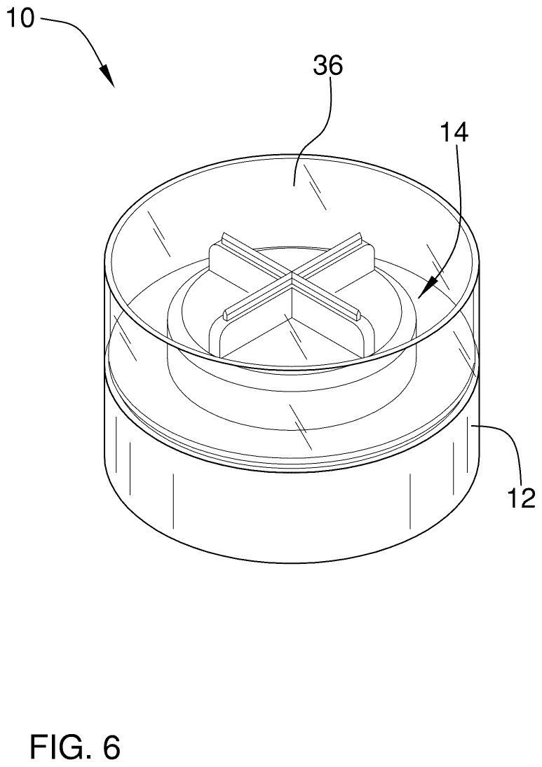

The tomato scoring device 10 further includes a safety cover 36 that is designed to cover the cross-shaped projection 32. As shown in FIGS. 1 and 6, the safety cover 36 is detachably couplable to the base 12. In the exemplary embodiment, the safety cover 36 is a cylindrical cup that matches the base 12. However, in another possible embodiment, the safety cover 36 could be smaller to only fit over the platform 26.

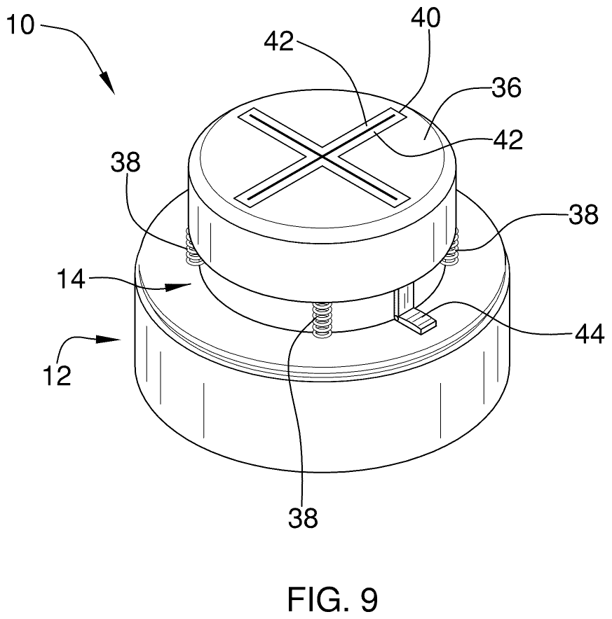

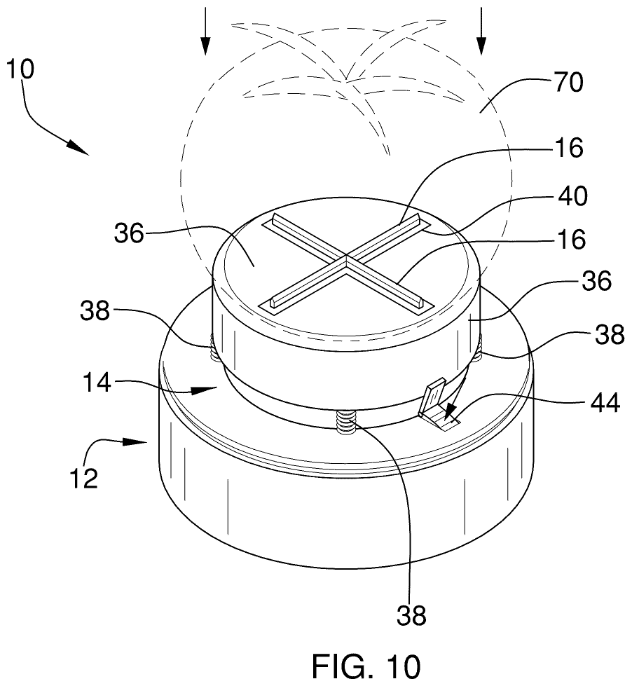

FIGS. 9 and 10 show an alternative embodiment of the safety cover 36, wherein the safety cover 36 is coupled to the base 12 by spring-loaded legs 38 designed to bias the safety cover 36 away from the base 12. In this embodiment, the safety cover 36 includes a cross-shaped opening 40. The safety cover 36 is designed to be moved toward the base 12 to expose the blades 16 through the cross-shaped opening 40 when the tomato 70 is pressed against the safety cover 36, and is designed to be moved away from the base 12 by the spring-loaded legs 38 to cover the blades 16 when the tomato 70 is removed from the safety cover 36. In addition, the safety cover 36 includes resilient lips 42 mounted in the cross-shaped opening 40. The resilient lips 42 are designed to wipe the blades 16 when the safety cover 36 is moved away from the base 12. In this manner, the blades 16 are always covered and only exposed when cutting the tomato 70, thereby protecting persons from accidental cuts. In addition, the blades 16 can be automatically cleaned of tomato juices and pulp, thereby allowing easy clean up by wiping off the top of the safety cover 36 without ever having to touch the blades 16. A slide lock 44 could be included in the base 12 to lock the safety cover 36 in place and prevent accidental movement and exposure of the blades 16.

FIG. 8 shows how to use the tomato scoring device 10. The user simply places the bottom of the tomato 70 on the blades 16. The user then gently presses the tomato 70 into the blades 16. Since the blades 16 project out slightly from the blunt cross-shaped projection 32, only the blades 16 pierce the skin of the tomato 70, which is effectively stopped from being pressed further by the cross-shaped projection 32. The user thereby creates a cross-shaped cut in the tomato 70 in one easy movement with very little stress or effort.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tomato scoring device comprising:
a base having a top surface, a bottom surface, and a perimeter surface connecting said top surface and said bottom surface;
a support projection being disposed on said top surface of said base; and
four blades being mounted in said support projection, said blades being positioned in a cross shape such that said blades are arranged in two aligned intersecting pairs perpendicular to one another, each of said blades including an exposed portion projecting out of said support projection a distance sufficient only to pierce a skin of a tomato when the tomato is pressed into said blades to create a cross-shaped cut.

2. The tomato scoring device of claim 1, wherein said exposed portion of said blades is in the range of 1.00 mm to 3.50 mm in height.

3. The tomato scoring device of claim 1, wherein:
said support projection is in the form of a platform including an upper surface and a side surface extending to said top surface of said base; and
said blades are disposed to project out of said upper surface.

4. The tomato scoring device of claim 1, wherein:
said support projection includes a platform and a cross-shaped projection;
said platform includes an upper surface and a side surface extending to said top surface of said base;
said cross-shaped projection is disposed to project out of said upper surface of said platform; and
said blades are mounted in said cross-shaped projection.

5. The tomato scoring device of claim 1, wherein:
said platform is cylindrical; and
said base is cylindrical.

6. The tomato scoring device of claim 5, wherein:
said base has a diameter in the range of 60 mm to 100 mm; and
said platform has a diameter smaller than the diameter of said base and in the range of 40 mm to 70 mm.

7. The tomato scoring device of claim 1, further including a suction cup attached to said bottom surface of said base.

8. The tomato scoring device of claim 1, further including a safety cover being configured to cover said cross-shaped projection.

9. The tomato scoring device of claim 8, wherein said safety cover is detachably couplable to said base.

10. The tomato scoring device of claim 8, wherein:
said safety cover is coupled to said base by spring-loaded legs configured to bias said safety cover away from said base;
said safety cover includes a cross-shaped opening; and
said safety cover is configured to be moved toward said base to expose said blades through said cross-shaped opening when the tomato is pressed against said safety cover, and is configured to be moved away from said base by said spring-loaded legs to cover said blades when the tomato is removed from said safety cover.

11. The tomato scoring device of claim 10, wherein:
said safety cover includes resilient lips mounted in said cross-shaped opening; and
said resilient lips are configured to wipe said blades when said safety cover is moved away from said base.

12. The tomato scoring device of claim 2, wherein:
said support projection includes a platform and a cross-shaped projection;
said platform includes an upper surface and a side surface extending to said top surface of said base;
said cross-shaped projection is disposed to project out of said upper surface of said platform; and
said blades are mounted in said cross-shaped projection.

13. The tomato scoring device of claim 12, further including a safety cover being configured to cover said cross-shaped projection.

14. The tomato scoring device of claim 13, wherein said safety cover is detachably couplable to said base.

15. The tomato scoring device of claim 13, wherein:
said safety cover is coupled to said base by spring-loaded legs configured to bias said safety cover away from said base;
said safety cover includes a cross-shaped opening; and
said safety cover is configured to be moved toward said base to expose said blades through said cross-shaped opening when the tomato is pressed against said safety cover, and is configured to be moved away from said base by said spring-loaded legs to cover said blades when the tomato is removed from said safety cover.

16. The tomato scoring device of claim 15, wherein:
said safety cover includes resilient lips mounted in said cross-shaped opening; and
said resilient lips are configured to wipe said blades when said safety cover is moved away from said base.

17. The tomato scoring device of claim 14, wherein:
said platform is cylindrical; and
said base is cylindrical.

18. The tomato scoring device of claim 17, wherein:
said base has a diameter in the range of 60 mm to 100 mm; and
said platform has a diameter smaller than the diameter of said base and in the range of 40 mm to 70 mm.

19. The tomato scoring device of claim 18, further including a suction cup attached to said bottom surface of said base.

20. A method of scoring a tomato, said method comprising the steps of:
providing a tomato scoring device comprising:
a base having a top surface, a bottom surface, and a perimeter surface connecting said top surface and said bottom surface;
a support projection being disposed on said top surface of said base; and
four blades being mounted in said support projection, said blades being positioned in a cross shape such that said blades are arranged in two aligned intersecting pairs perpendicular to one another, each of said blades including an exposed portion projecting out of said support projection a distance sufficient only to pierce a skin of a tomato when the tomato is pressed into said blades to create a cross-shaped cut;
placing a bottom of the tomato on said blades; and
pressing said tomato into said blades and thereby piercing only the skin of the tomato and thereby creating a cross-shaped cut in the tomato.
